(19) United States
(12) Patent Application Publication
(10) Pub. No.: US 2006/0040241 A1
(43) Pub. Date: Feb. 23, 2006

(54) Novel stimulative triple disposition lettered didactic cue T-shirt/sweat shirt style garment teaching tool

(76) Inventor: Thomas Percival Logan, Nashville, TN (US)

Correspondence Address: Thomas P. Logan, DDS, MD, 2111 Golf Club Lane, Nashville, TN, 37215-1223, US

(21) Appl. No.: 10/914,760

(22) Filed: Aug. 10, 2004

(51) Int. Cl. G09B 19/00

(52) U.S. Cl. 434/156

(57) ABSTRACT

A teaching tool consisting of T-shirt style garments lettered with salient high value didactic content presented in three coordinating mutually enhancing special dispositions (mirror image, inverted, and standard grammar) for low cost, low technology, universally available, formal and informal, school and home, group and individual use. It enhances knowledge acquisition by creating and potentiating novelty, curiosity, surprise and amusement qualities. This tool is suited well for vocabulary, definitions, tables, formulas and number manipulations and is suited to biographic sketches, historical gems and general curricular data for all ages.

### BACKGROUND OF THE INVENTION

1. Field of Invention

This invention relates to education. This invention is a teaching aid and method of presenting salient informational goals in a uniquely stimulative way. The main mission and vision of this invention of object and methods is to increase the overall literacy and scholarship of our learner community by broadly and widely enhancing exposures to salient information by lettering T-shirt, sweatshirt and similar garments in a triple display. Relying on the American penchant for using T-shirts to convey information this device combines this pervasive and strong, well accepted inclination with pedagogic and language steps.

As illustrated by early teaching entities such as Head Start pre-school style programs the need for enriching education in all dimensions is a problem to be solved. One of the better ways for students to retain lessons is through repetition. A learning tool that will provide exercises without creating boredom is presented. The inventor seeks to alleviate this aspect by using this novel, repetitious, stimulating and surprising process to enrich learning.

### BRIEF SUMMARY OF THE INVENTION

Solutions to the problems of improving education and learning in schools and across the full scope of the American culture remain in demand. To contribute to meeting this demand in a pervasive way both informally and formally, a system relying on the use of vast surfaces available and by custom accepted as appropiate, for information display is presented.

The uncomplicated expedient of arranging salient high-value scholastic goals and objectives on T-shirt and similar apparel with compelling ingenuity and distributing them throughout our population in schools and homes provides advantageous solutions with large permutations and combinations.

Displaying the same compact data sets on apparel surfaces in a novel three disposition integrated way, binds attention, repetition, amusement curiosity and surprise with interpersonal sharing and competitive behaviors that can be used by teachers, parents and young learners in many ways.

The apparel surfaces are disposed as follows:
1. Lettered in mirror image on the shirt front below the neckline
2. Lettered upside down on the lower front section of the shirt above the hemline
3. Lettered in standard grammatical style on the back of the shirt below the nape This design encourages attention as a focus in the classroom and playground settings and becomes embedded in the environmental background of public and private milieu. This attention increases learning both actively and passively.

### BRIEF DESCRIPTION OF THE TWO DRAWINGS

FIG. 1 is a front view of a collarless T-shirt or like stlyed textile garment lettered in two dispositions designated as A and B.

FIG. 1A is lettering in mirror image at the top area just below the neckline across the chest

FIG. 1B is lettering disposed upsidedown (inverted) in foot-to-head dimension above the hem line across the waistline

FIG. 2 is a dorsal or rear view of the above garment lettered below the nape across the back in standard grammatical disposition and style

### DETAILED DESCRIPTION OF THE INVENTION

This educational and learning invention pertains to an apparatus, a tool and method consisting of T-shirt style garments lettered with salient high value didactic content presented in three coordinating mutually enhancing special dispositions (mirror image, inverted and standard grammar) for low cost, low technology, universally available use. A tool for efficiently proliferating both broadly and in nitches the cues and acquisition of knowledge by individuals and interacting student and teacher, family and peer group by use of low cost T-shirt and similar apparel art craft surfaces as classroom curriculum and general living display of educational materials to visually impress information on people.

This invention consists of the lettering of factual, educational cues onto the front and back surfaces of T-shirts, sweat shirts and other apparel in a novel three disposition integrated way. The intended purpose is the formation of and reinforcing of the areas of vocabulary and language skills, mathematics, the sciences and communication. We intend that our invention should primarily be used in educational settings, from kindergarten through the primary and secondary grades, to the collegiate and graduate levels. This invention could be used also in business and technical settings to introduce and/or reinforce certain concepts, designs and innovations. Further applications could be introduced into home-school and general domestic settings, in which people could wear the apparel routinely.

Relying on the American penchant for using T-shirts and similar garments to convey information this device combines this pervasive and strong well accepted inclination with pedagogic and language steps in such a unique way as to facilitate acquisition, retention and use of multiple goals and objectives in vocabulary, word definitions, arithmetic and so forth.

The psychological novelty of this invention is inherent in the manner in which the information is uniquely displayed on the apparel. The triple display generates enhanced learning by creating novelty, repetition, surprise and stimulation by curiosity, fun and focus.

This low technology potentiator consists of displaying discrete learning goals and objectives across a wide spectrum, including but not limited to vocabulary, numerals, tables, axiomatic and literary cues.

The educational lesson content is placed on the apparel as follows: (1) in mirror image in the area of the garment front beneath the neckline [requiring the wearer to face a mirror to read it] (2) inverted upside-down on the waist of the front of the garment requiring the wearer to look downward or towards their feet to read legibly and (3) in standard left to right grammatical, numerical and literature style on the back of the garment so as to be read by other individuals and by the wearer when getting dressed. The image on the back would also be legible to other students and allow for mutuality of learning and using the visual cues.

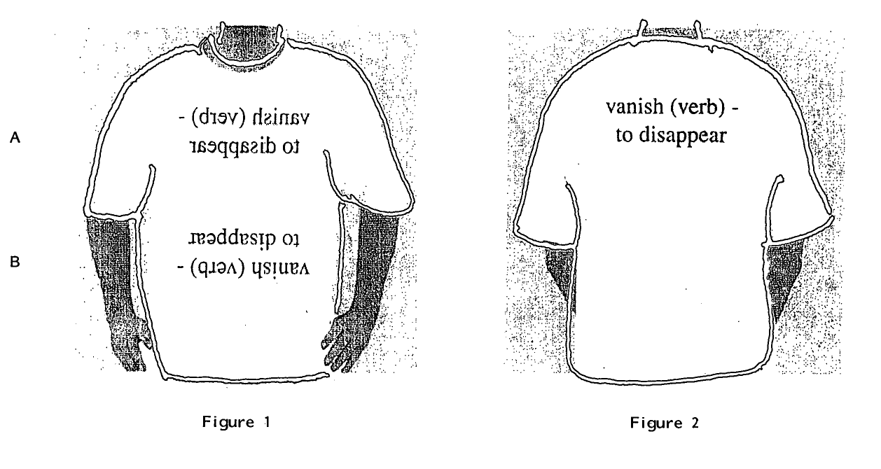

With reference to FIG. 1, there is depicted a front view of T-shirt with text arrangement in two ways. A mirror image below the neckline FIG. 1A and an inverted upside-down image below the waist near the bottom FIG. 1B . FIG. 2 depicts the back of the same garment with the same text displayed in standard format reading left to right. While the teaching aid of the present invention is shown in FIG. 1 and FIG. 2, other common garments and lettering methods may be used. This teaching aid has the advantage of being safe, comfortable, inexpensive and free-standing.

In the process of making, a garment is selected for lettering according to the size, gender and status of the intended wearer. The sizes would be off-the-shelf typical designations such as small, medium large and adult, adolescent, child, etc. The lettering size and font style would be selected to fit the available area of the garment and subject presented. Lettering may be applied in freehand fashion entirely, with stencils, templates, guides, etc. Lettering may also be applied with silk screening, iron-on tranfer techniques, embroidery or incorporated into the fabric during weaving. The use of removable panels using interlocking fabric tape or buttons whereby words and illustrations could be changed and exchanged would be an option. Color selections for garments and lettering may be simple black on white or resplendent to meet desires of teachers and wearers. Color combinations of garment and lettering may be selected to meet desired ends such as having grammatical constructs color-coded. For example, verbs could be lettered in blue, adjectives in red, nouns in yellow, etc. Where formulas are displayed that use exponents the exponents may be letter for example in purple to focus the learners.

Methods for using the invention are numerous, open ended, scalable and subject to inventiveness and ingenuity. In class or other multiple interactive setting the garments would come in either sets or single item availablity. Teachers might assign a class of students the same word and definition to be worn by all students for directed exercises in the classroom or during recess. Teachers might assign different texts to many students for interactive learning of a set of words, definitions, facts, numbers, formulas within the scope of a typical lesson plan. Teachers might assign words and other information that compose a poem or story, or answer or ask a question when students are queued for doing so.

Individuals might select their own unique garments and content for competitive or idiosyncratic fulfillments. Individuals might be clothed in garments with texts of their choice or because their parents or tutors or teachers might want to add to solving learning problems of individuals with particular items.

The foregoing description of a preferred embodiment of the invention has been presented for the purpose of illustration and description; it is not intended to be exhaustive or to limit the invention to the precise form disclosed. Obvious modifications and variations are possible. The embodiment was chosen and described to provide the best illustration of the invention and its practical application to enable one of ordinary skill in the art to utilize the invention in various ways.

The creative intention of this invention is to evolve in making contributions to the educational mass needed to support our society's growth and development. This is to generate an expectation that runs along a pathway not unlike that of our postage stamp system's provision of millions of daily exposures to thumbnail salient historical, biographical and patriotic impressions.

What I claim as my invention is:

1. A teaching tool and aid composed of unique triple display of salient didactic goals and objectives lettered on commonly worn garments. That the singular concurrent per garment three-way (mirror image, upside down and prose) presentation promotes knowledge acquisition and practical intellectual interaction in the teaching-learning nexus.
